(19) United States
(12) Patent Application Publication
(10) Pub. No.: US 2002/0069074 A1
(43) Pub. Date: Jun. 6, 2002

(54) MIXING DIVERSELY ENCODED DATA STREAMS

(76) Inventors: MARK E. EIDSON, TEMPE, AZ (US); KARL H MAURITZ, CHANDLER, AZ (US); PAUL S. GRYSKIEWICZ, CHANDLER, AZ (US)

Correspondence Address: TIMOTHY N TROP, TROP PRUNER HU & MILES, 8554 KATY FREEWAY STE 100, HOUSTON, TX, 77024

(21) Appl. No.: 09/185,248

(22) Filed: Nov. 3, 1998

(51) Int. Cl. G10L 19/00

(52) U.S. Cl. 704/500

(57) ABSTRACT

A method to combine diversely encoded data streams includes receiving a first data stream in a first encoded format, decoding the first data stream into a decoded format, obtaining a second data stream in the decoded format, and combining the decoded first data stream with the second data stream. The first encoded format may, for example, be associated with a video data stream, an audio data stream, or a multimedia data stream. The decoded format may be any format which allows two data streams to be combined in a substantially direct manner such as, for example, a linear pulse code modulated (LPCM) data format.

### BACKGROUND

The invention relates to the field of signal processing, and more particularly to techniques (methods and devices) to combine diversely encoded digital data streams.

In many current systems, digital audio data may be represented as a raw linear pulse code modulated (LPCM) data stream, or as a multi-channel perceptually encoded data stream. Perceptual encoding schemes include the Movie Picture Experts Group (MPEG) standards such as MPEG-2 Parts 3 and 7, and audio compression format AC-3. Copies of the MPEG standards may be obtained from the International Organization for Standardization (ISO) and the International Electrotechnical Commission (IEC) as document ISO/IEC 13818. The AC-3 specification may be obtained from the Advanced Television Systems Committee, publication A/52 entitled “Digital Audio Compression (AC-3) Standard.”

Referring to FIG. 1, a conventional computer system 100 for playing audio data may include host processor 102, multimedia source 104, interface circuit 106, and analog circuit 108. Source 104 may, for example, be a digital video disk (DVD) and encoded data 110 may include an audio data portion and a video data portion. Interface 106 and analog 108 circuits may implement an audio encoder/decoder (CODEC) in accordance with the AC '97 CODEC component specification (available from Intel Corporation). Typically, host processor 102 parses encoded audio data stream 112 from encoded data stream 110 and conveys it to interface circuit 106. Interface circuit 106 may then decode the audio data and convey a raw audio data stream 114 to analog circuit 108. Analog circuit 108, in turn, may then generate the necessary analog signals to produce an audible sound, i.e., audio signal 116.

While each perceptual encoding scheme may be implemented differently, they all compress raw audio data. In compressed form two encoded audio data signal streams, or an encoded audio data stream and a raw audio data stream may not be directly combined by host processor 102. This limitation prevents integrating the presentation of a DVD movie, or other perceptually encoded audio (or audio-video) presentation with other computer system functions such as an audible notification of incoming electronic mail or an audible system notice (e.g., completion of a system backup operation). Thus, there is a need for a mechanism that allows a user to combine encoded and raw audio data streams.

### SUMMARY

In one embodiment the invention provides a method to combine two or more data streams. The method includes receiving a first data stream in a first encoded format, decoding the first data stream into a decoded format, obtaining a second data stream in the decoded format, and combining the decoded first data stream with the second data stream. The first encoded format may, for example, be associated with a video data stream, an audio data stream, or a multimedia data stream. The decoded format may be any format which allows two or more data streams to be combined in a direct manner. Instructions representing the method may be stored in any media that is readable and executable by a computer system.

In another embodiment, the invention provides a computer system comprising a multimedia source, a host processor to receive an encoded data stream from the multimedia source, a decoder to decode at least a portion of the received encoded data stream, a mixer to combine two or more data streams (each of which are in a decoded format), and an encoder to encode the combined data streams.

### BRIEF DESCRIPTION OF THE DRAWINGS

FIG. 1 illustrates a computer system having conventional audio play back capability.

FIG. 2 shows a flow chart in accordance with one embodiment of the invention.

FIG. 3 shows a computer system in accordance with one embodiment of the invention.

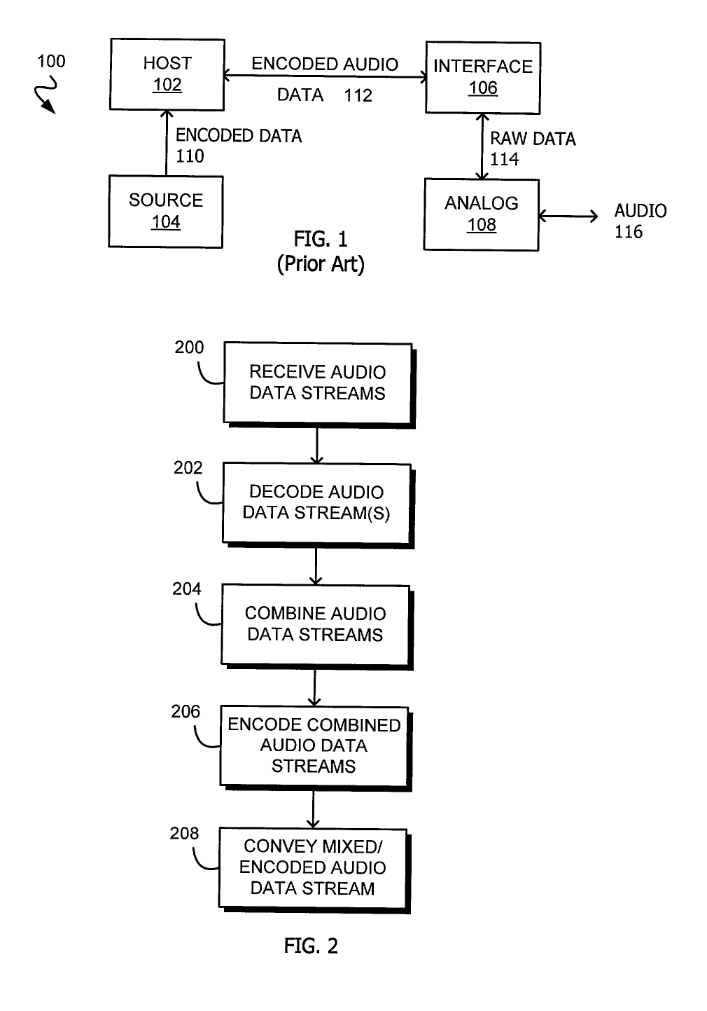

### DETAILED DESCRIPTION

Techniques (including methods and devices) to combine diversely encoded data streams are described. The following embodiment, described in terms of audio data streams, is illustrative only and is not to be considered limiting in any respect.

Referring to FIG. 2, one embodiment of a method in accordance with the invention includes receiving two or more audio data streams, of which at least one is format in accordance with a perceptually based encoding scheme (block 200). For example, a first data stream may be raw single channel (monophonic) LPCM data, and the second data stream may be an AC-3 encoded 5.1 audio data stream. Those data streams which are encoded, are decoded into a raw format such as LPCM (block 202). The raw data streams may then be combined in any desired manner (block 204). For instance, the first data stream (e.g., single channel LPCM data) may be combined so that it is heard in a specified one (or more) of the second data stream's channels (e.g., AC-3 encoded 5.1 data). Alternatively, the first data stream may be combined so that it is heard in all channels of the second data stream. Further, the relative volume levels of the first and second data streams may be adjusted during the act of combining. The combined data streams may be encoded using a perceptual encoding scheme (block 206) and transmitted to a down-stream component for further processing or storage (block 208). Because current CODEC devices are not capable of mixing multiple data streams where some of the data streams are perceptually encoded and others are not, encoding the combined audio data streams allows use of conventional audio devices such as the AC '97 CODEC. (A CODEC device typically includes a digital interface circuit and an analog circuit.) Thus, a method in accordance with the invention may be used to create new audio streams consisting of combinations of new or existing data streams which may be processed as ordinary (i.e., non-combined) perceptually encoded audio data streams.

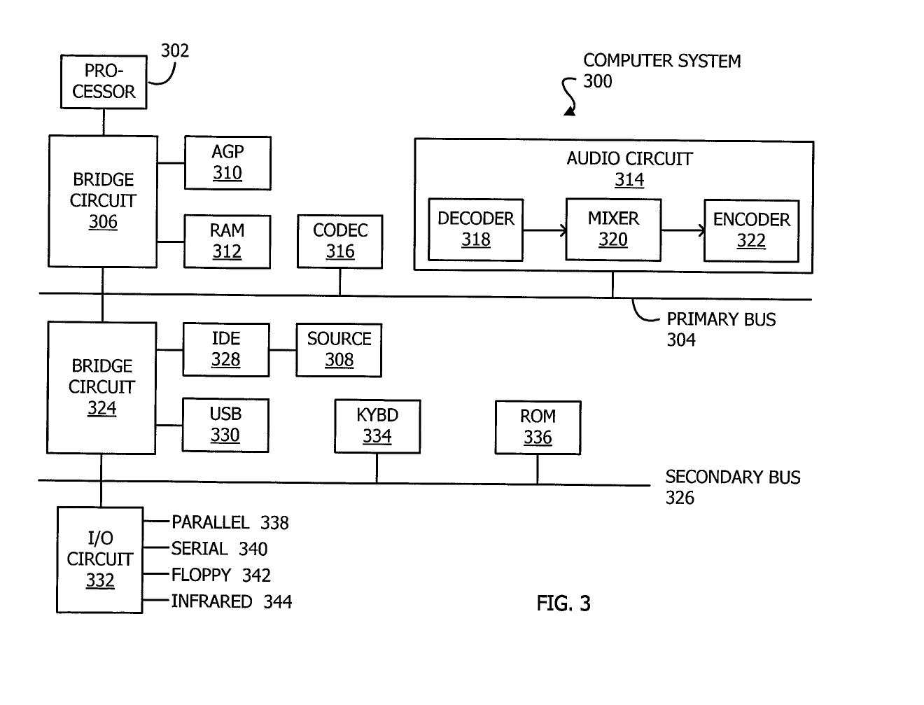

Referring to FIG. 3, a computer system 300 in accordance with one embodiment of the invention is shown. Computer system 300 may include host processor 302 coupled to primary bus 304 through bridge circuit 306. Bridge circuit 306 may provide an accelerated graphics port (AGP) 310. Bridge circuit 306 may also provide an interface to couple system random access memory (RAM) 312 to primary bus 304. Illustrative host processor(s) 302 include the PENTIUM® processor family of processors and the 80×86 families of processors from Intel Corporation. One illustrative bridge circuit 306 is the 82443LX PCI-to-AGP controller manufactured by Intel Corporation. An illustrative primary bus may conform to the peripheral component interface (PCI) standard.

Bridge circuit 324 may couple system bus 304 to secondary bus 326, while also providing integrated device electronics (IDE) 328 interface through which multimedia source 308 may be coupled to computer system 300. Bridge circuit 324 may also provide universal serial bus (USB) interface 330. Source 308 may be, for example, a DVD which provides an encoded data stream to computer system 300. One illustrative bridge circuit 324 is the 82371AB PCI-to-ISA/IDE controller made by Intel Corporation. Illustrative secondary buses 326 may conform to the PCI, industry standard interface (ISA), and extended industry standard interface (EISA) standards. Input-output (I/O) circuit 332, keyboard controller (KYBD) 334, and system read only memory (ROM) 336 may also be coupled to secondary bus 326. Input-output circuit 332 may provide an interface for parallel 338 and serial 340 port devices, floppy disks 342, and infrared devices 344.

Audio circuit 314, including decoder 318, mixer 320, and encoder 322, and CODEC 316 may also be coupled to primary bus 304 and receive encoded data from source 308. An encoded data stream typically includes an audio data portion and a video data portion. Host processor 302 parses the encoded data stream provided by source 308 to generate an encoded video data stream and an encoded audio data stream. The encoded video data stream may be processed by a video unit (not shown), while the encoded audio stream may be routed to decoder 318 via primary bus 304. Decoder 318 decodes the encoded audio stream into a raw audio data stream (e.g., an audio data stream in LPCM format) and routes it to mixer 320. Mixer 320, in turn, combines the raw audio data stream with one or more other raw audio data streams (provided to mixer 320 via primary bus 304 or decoder 318) to generate a combined audio data stream. Output from mixer 320 may be encoded by encoder 322, which may apply any suitable or desirable perceptual encoding scheme. The encoded/combined audio data stream may then be conveyed to CODEC 316 (in digital format) via primary bus 304 where it is processed for eventual presentation to a user.

In the embodiment of FIG. 3, audio circuit 314 is a hardware component operatively coupled to computer system 300 via primary bus 304. In an alternative embodiment, one or more of decoder 318, mixer 320, and encoder 322 may be implemented within the digital controller device in accordance with the AC '97 specification, or bridge circuit 306. In yet another embodiment, one or more of decoder 318, mixer 320, and encoder 322 may be implemented as software modules, stored in RAM 312 or ROM 336 and executed by host processor 302.

Other embodiments are within the scope of the following claims. For instance, encoded data streams are not limited to audio data streams; they may also comprise video or multimedia data streams for instance. Further, encoded audio data streams are not limited to those provided by a DVD device—audio data streams suitable for combining in accordance with the invention may be obtained from, among other sources, compact disks (CDs), microphones, and sound effect software applications. In addition, decoder 318, mixer 320, and encoder 322 may be implemented as software modules executed by a programmable control device. A programmable control device may be a computer processor or a custom designed state machine. Custom designed state machines may be embodied in a hardware device such as a printed circuit board comprising discrete logic, integrated circuits, or specially designed application specific integrated circuits (ASICs). Storage devices suitable for tangibly embodying program modules include all forms of non-volatile memory including, but not limited to: semiconductor memory devices such as EPROM, EEPROM, and flash devices; magnetic disks (fixed, floppy, and removable); other magnetic media such as tape; and optical media such as CD-ROM disks.

While the invention has been disclosed with respect to a limited number of embodiments, numerous modifications and variations will be appreciated by those skilled in the art. It is intended, therefore, that the following claims cover all such modifications and variations that may fall within the true sprit and scope of the invention.

What is claimed is:

1. A method to combine diversely encoded audio data streams, comprising:
receiving a first audio data stream in a first perceptually based format;
decoding the first audio data stream into a raw format;
obtaining a second audio data stream in the raw format; and
combining the decoded first audio data stream with the second audio data stream.

2. The method of claim 1, further comprising encoding the combined audio data stream into a second perceptually based format.

3. The method of claim 2, wherein the act of encoding the combined audio data stream into the second perceptually based format comprises encoding the combined audio data stream into an AC-3 format.

4. The method of claim 2, wherein the act of encoding the combined audio data stream into the second perceptually based format comprises encoding the combined audio data stream into a MPEG-2 format.

5. The method of claim 2, further comprising transmitting the encoded combined audio data stream to a circuit.

6. The method of claim 5, wherein the combined audio data stream comprises a digital data stream.

7. The method of claim 1, wherein the act of receiving a first audio data stream comprises receiving an audio data stream encoded in the AC-3 format.

8. The method of claim 1, wherein the act of receiving a first audio data stream comprises receiving an audio data stream encoded in the MPEG-2 format.

9. The method of claim 1, wherein the act of decoding the first audio data stream into a raw format comprises decoding the first audio data stream into a linear pulse code modulated format.

10. The method of claim 1, wherein the act of combining comprises mixing the first audio data stream and the second audio data stream to generate a single composite audio data stream.

11. The method of claim 1, wherein the act of obtaining a second audio data stream in a raw format comprises:
receiving a second audio data stream in a third perceptually based format; and
decoding the second audio data stream into the raw format.

12. A program storage device, readable by a programmable control device, comprising:
instructions stored on the program storage device for causing the programmable control device to
receive a first audio data stream in a first perceptually based format;
decode the first audio data stream into a raw format;
acquire a second audio data stream in the raw format; and
combine the decoded first audio data stream with the second audio data stream.

13. The program storage device of claim 12, wherein the instructions further comprise instructions to encode the combined audio data stream into a second perceptually based format.

14. The program storage device of claim 105, further comprise instructions to transmit the encoded combined audio data stream to a circuit.

15. The program storage device of claim 14, wherein the circuit comprises a CODEC circuit.

16. The program storage device of claim 12, wherein the instruction to acquire a second audio data stream in a raw format comprise instructions to:
receive a second audio data stream in a third perceptually based format; and
decode the second audio data stream into the raw format.

17. A computer system comprising:
a multimedia source;
a host processor to receive an encoded data stream from the multimedia source and to extract a first encoded audio stream from the encoded data stream;
a decoder to receive the first encoded audio stream from the host processor and to generate a first raw audio stream based on the first encoded audio stream;
a mixer to combine the first raw audio stream and a second raw audio stream to generate a combined audio stream; and
an encoder to receive the combined audio stream and to generate a second encoded audio stream.

18. The computer system of claim 17, further comprising an audio CODEC circuit to receive the combined audio stream.

19. A method to combine diversely encoded data streams, comprising:
receiving a first data stream in a first compressed format;
decoding the first data stream into an uncompressed format;
obtaining a second data stream in the uncompressed format; and
combining the decoded first data stream with the second data stream.

20. The method of claim 19, further comprising encoding the combined data stream into a second compressed format.

21. The method of claim 19, wherein the first data stream comprises an audio data stream.

22. The method of claim 19, wherein the first data stream comprises a video data stream.

23. The method of claim 22, wherein the compressed format comprises a MPEG format.
